(19) United States
(12) Patent Application Publication
(10) Pub. No.: US 2007/0139574 A1
(43) Pub. Date: Jun. 21, 2007

(54) Plateless LCD Unit

(76) Inventors: Byung-soo Ko, Seoul (KR); Ji-Hyung Kim, Kyonggi-Do (KR); Byoung-kyu Kim, Busan-City (KR)

Correspondence Address: 3M INNOVATIVE PROPERTIES COMPANY, PO BOX 33427, ST. PAUL, MN, 55133-3427, US

(21) Appl. No.: 11/275,198

(22) Filed: Dec. 19, 2005

(51) Int. Cl. G02F 1/1333

(52) U.S. Cl. 349/58

(57) ABSTRACT

Directly illuminated liquid crystal display (LCD) units include an LCD panel, a backlight cavity, an optical film stack located between the LCD panel and the backlight cavity, and a supporting structure. The supporting structure, which is relatively low-profile and lightweight, is positioned to maintain the optical film stack in a substantially flat condition. In some cases, the supporting structure includes a flexible support such as a film, a filament, or an array of filaments that are held taut in at least one dimension. In some cases, the supporting structure includes a rigid elongated support that covers only a portion of a useful area of the film stack.

### BACKGROUND OF THE INVENTION

The present invention generally relates to the field of liquid crystal displays. In particular, the invention relates to a system for supporting optical film stacks within liquid crystal display devices.

Liquid crystal displays (LCDs) are optical displays used in devices such as laptop computers, hand-held calculators, digital watches, and televisions. Some LCDs include a light source that is located to the side of the display, with a light guide positioned to guide the light from the light source to the back of the LCD panel. Other LCDs, for example, some LCD monitors and LCD televisions (LCD-TVs), are directly illuminated using a number of light sources positioned behind the LCD panel. This arrangement is increasingly common with larger displays because to achieve a certain level of display brightness, the light power requirements increase with the square of the display size, whereas the available real estate for locating light sources along the side of the display only increases linearly with display size. In addition, some LCD applications, such as LCD-TVs, require that the display be bright enough to be viewed from a greater distance than other applications, and the viewing angle requirements for LCD-TVs are generally different from those for LCD monitors and hand-held devices.

Some LCD monitors and most LCD-TVs are commonly illuminated from behind by a number of fluorescent tubes. These light sources are linear and stretch across the full width of the display, with the result that the back of the display is illuminated by a series of bright stripes separated by darker regions. Such an illumination profile is not desirable, and so a diffuser layer is used to smooth the illumination profile at the back of the LCD device. When the layer is thin, a uniform luminance distribution cannot be obtained easily due to warp and undulation of the layer. As the scale of LCD devices has become greater in recent years, warp and undulation of the diffuser layer has become more likely to occur and the thickness of the diffuser layer itself has been increased to suppress such problems. However, the increased weight of the diffuser layer resulting from increased thickness and area of the layer has become another problem.

In addition, the diffuser layers can have problems with distortion due to the high temperature exposure of the backlight systems, as well as from moisture absorption.

### BRIEF SUMMARY

Directly illuminated liquid crystal display (LCD) units are disclosed that include an LCD panel, a backlight cavity, a film stack disposed between the LCD panel and the backlight cavity, and a supporting structure disposed to maintain the film stack in a substantially flat condition. The film stack comprises at least one flexible optical film, and can include a flexible diffuser film. The film stack itself is also flexible. The supporting structure includes at least one flexible support held taut in at least one dimension, and/or at least one rigid elongated support covering only a portion of a useful area of the film stack.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a cross-sectional view of a liquid crystal display (LCD) system.

FIG. 2 is an exploded perspective view of the LCD system of FIG. 1.

FIG. 3A is another exploded perspective view of the LCD system of FIG. 1, with some system components omitted.

FIG. 3B is a blown-up perspective view of a portion of the LCD system of FIG. 3A.

FIG. 3C is another blown-up perspective view of a portion of the LCD system of FIG. 3A.

FIG. 4 is an exploded perspective view of another LCD system.

FIG. 5 is an exploded perspective view of another LCD system.

FIG. 6 is an exploded perspective view of another LCD system.

In the figures, like reference numbers have been used to denote like parts.

### DETAILED DESCRIPTION

Unless otherwise indicated, all numbers expressing feature sizes, amounts, and physical properties used in the specification and claims are to be understood as being modified by the term “about.” Accordingly, unless indicated to the contrary, the numerical parameters set forth in the present specification and claims are approximations that can vary depending upon the desired properties sought to be obtained by those skilled in the art utilizing the teachings disclosed herein.

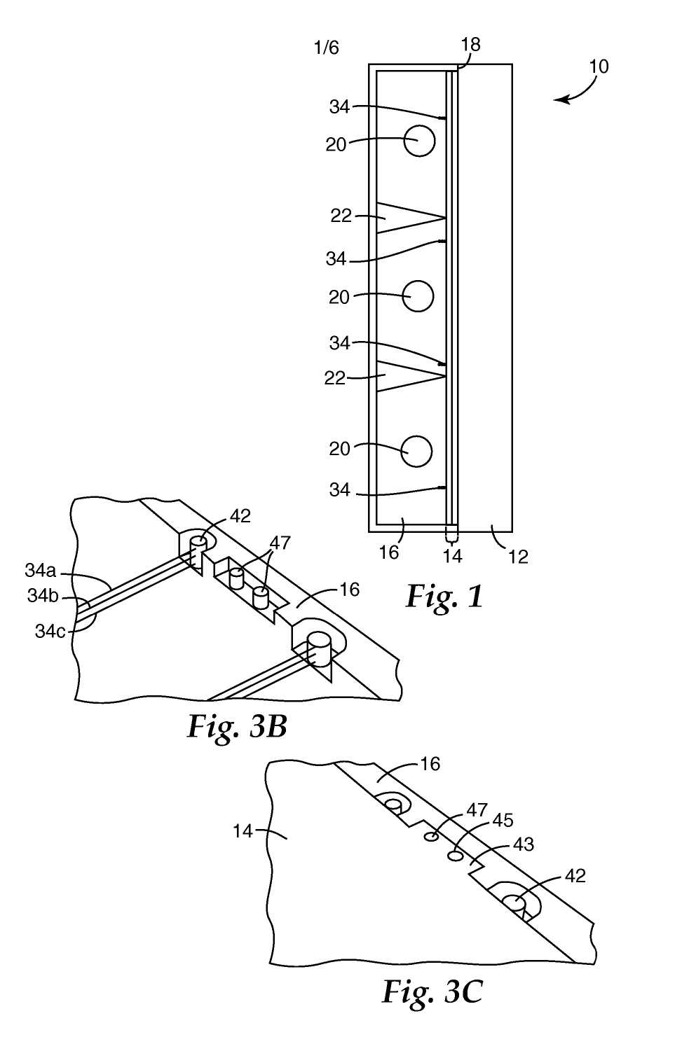

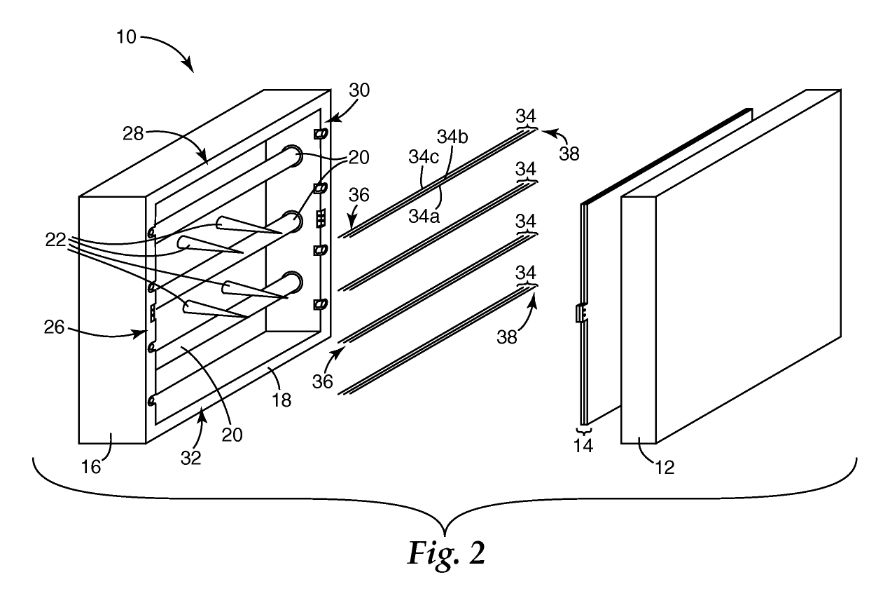

FIGS. 1 and 2 show a cross-sectional view and an exploded perspective view, respectively, of a liquid crystal display (LCD) system 10, and will be discussed in conjunction with one another. LCD system 10 includes an LCD panel 12 with an absorbing polarizer (not shown), an optical film stack 14, a backlight cavity 16 having a surface 18, light sources 20, and support posts 22. Light sources 20 are positioned in backlight cavity 16 and direct light through optical film stack 14 to LCD panel 12, where a resulting image is perceived by a viewer positioned in front of LCD system 10. LCD system 10 may also include additional components or features between LCD panel 12 and backlight cavity 16.

Optical film stack 14 is positioned between LCD panel 12 and backlight cavity 16 and affects the light propagating from backlight cavity 16 so as to improve the operation of LCD system 10. Optical film stack 14 can include, but is not limited to: light-directing films, diffuser-type films, turning films, brightness-enhancing films, multi-layer polymer films, reflective polarizing films, and absorbing polarizers. For example, optical film stack 14 may include a diffuser film so as to enhance the uniformity of the illumination light incident on LCD panel 12. This in turn can provide a uniformly bright image on LCD panel 12 when perceived from a viewer in front of LCD system 10. Typically, each component of optical film stack 14 (i.e., the diffuser film, if present, the reflective polarizing film, if present, the brightness enhancing film, if present, and so forth) is a film that can flex, bend, and the like if manipulated by hand, and that sags under its own weight if removed from LCD system 10 and held at only one end or corner. Such flexibility also typically characterizes entire optical film stack 14, which can comprise a plurality of flexible optical films or can consist essentially of a single flexible optical film, if desired. Optical film stack 14 and each of its component film(s) is preferably sized, in both a length dimension and a width dimension, to at least fill the aperture of backlight cavity 16 and/or to at least fill the viewable area of LCD panel 12.

LCD system 10 can be or comprise an LCD-TV or any other LCD display system. Although LCD system 10 may in some cases include a thick, rigid diffuser plate, preferably any necessary diffusing function between the backlight cavity 16 and the LCD panel 12 is provided by one or more films in optical film stack 14, thus avoiding the need for any such diffuser plate, and enabling an LCD system 10 having a thinner overall profile and lighter weight. In order for optical film stack 14 to provide LCD system 10 with an optimal output brightness distribution, it is maintained in a substantially flat condition even though it is inherently flexible, and thus may be susceptible to warping, curling, sagging, and so on. Various low-profile supporting structures capable of holding optical film stack 14 in a flat condition, yet typically thinner and lighter weight than conventional diffuser plates, are described further below. One type of supporting structure includes a post that contacts the film stack at an isolated point or area. Another type of supporting structure extends across at least one lateral dimension of the backlight cavity aperture and/or of the viewable area of the LCD panel, and contacts the film stack along the length of the supporting structure. Some of these extended structures utilize thin components such as filaments, ribbons, or films that are inherently flexible but that are held taut to provide rigidity. Other extended structures utilize thin elongated components that are inherently rigid.

Suitable diffuser films have at least a first polymeric resin phase and a second phase such as beads, particles, voids, or the like that provide in combination a diffusing function. Suitable polymer materials may be amorphous or semi-crystalline, and may include homopolymer, copolymer, or blends thereof. Polymer foams may also be used. Examples of polymer materials include, but are not limited to: polycarbonate (PC), polystyrene (PS), acrylates, polypropylene (PP), poly(ethylene terephthalate) (PET), PET copolymers, polyethylene (PE), polymethyl methacrylate (PMMA), PMMA copolymers, poly(ethylene naphthalate) (PEN), PEN copolymers, cycloolefins, cycloolefin copolymers, acrylonitrile butadiene styrene (ABS), styrene acrylonitrile copolymers (SAN), epoxies, poly(vinylcyclohexane), PMMA/poly(vinylfluoride) blends, a tactic PP, poly(phenylene) oxide alloys, styrenic block copolymers, polyimide, polysulfone, poly(vinyl chloride), poly(dimethyl siloxane) (PDMS), polyurethanes, and poly(carbonate)/aliphatic PET blends. In some embodiments, the diffuser film can be made from a modified Acrylic Foam Tape, product number 4643, available from 3M Company, Saint Paul, Minn.

Backlight cavity 16 includes surface 18, light sources 20, and support posts 22. Surface 18 forms the perimeter of backlight cavity 16 proximate optical film stack 14 and has sides 26, 28, 30, and 32, which can be arranged to form a rectangle, if desired.

Backlight cavity 16 includes light sources 20 that illuminate LCD panel 12. Light sources 20 used in LCD system 10 are typically linear, cold cathode fluorescent tubes that extend across the length or width of LCD system 10. Other types of light sources may also be used, such as filament or arc lamps, light emitting diodes (LEDs), flat fluorescent panels (FFL), or external electrode fluorescent lamps (EEFL). In the case of LEDs, arrays of multicolored LEDs (such as red/green/blue) can be used, and the LEDs can be packaged or unpackaged, forward-emitting or side-emitting. Although FIGS. 1 and 2 show LCD system 10 having three light sources 20, LCD system 10 can have any number of light sources 20 as necessary to adequately illuminate LCD panel 12.

Support posts 22 of LCD system 10 are preferably mounted in or on backlight cavity 16 to help minimize gravitational sagging of optical film stack 14. Support posts 22 extend from backlight cavity 16 and contact optical film stack 14 at numerous points to provide support for optical film stack 14. Due to this support, optical film stack 14 is prevented from warping, sagging, curling, and the like. While optical film stack 14 is in contact with support posts 22, optical film stack 14 is preferably slightly distanced from LCD panel 12 by a thin air gap of between one millimeter and twenty-five millimeters. Alternatively, in some embodiments, optical film stack 14 may contact LCD panel 12. Although FIGS. 1 and 2 depict support posts 22 as right circular cones, support posts 22 may also be of other shapes as long as they do not substantially degrade the amount of light from light sources 20 that is transmitted to LCD panel 12. Support posts 22 may also be formed of transparent material so that the points of contact between support posts 22 and optical film stack 14 are not readily visible when observed from a viewer in front of LCD system 10. Any number of support posts 22 may be used as is necessary to effectively minimize sagging of optical film stack 14. Additionally, support posts 22 can be completely omitted from LCD system 10.

A plurality of elongated supports 34 each include filaments 34a-34c. Filaments 34a-34c extend across LCD system 10 such that a first end 36 of filaments 34a-34c contacts one side 26 of surface 18 and a second end 38 of filaments 34a-34c contacts the opposed side 30 of surface 18. Elongated supports 34 can be arranged along surface 18 in a parallel array, as shown, or they can be non-parallel to each other, whether slightly skewed or intersecting, including intersecting at right angles. For example, at least one elongated support 34 can extend from side 26 to side 30 of surface 18, and at least another elongated support 34 can extend from side 28 to side 32 of surface 18. Elongated supports 34 are positioned such that they contact optical film stack 14, preventing optical film stack 14 from sagging into backlight cavity 16 and maintaining optical film stack 14 in a substantially flat condition, thus avoiding warping, sagging, curling, or the like of optical film stack 14 caused by gravity or other influences. In some cases, each elongated support 34 and its component filaments 34a-34c are so thin and long as to be flexible, bendable, and non-self-supporting, i.e., if removed from LCD system 10 and held at one end they would sag and bend under their own weight. Nevertheless, by mounting filaments 34a-34c in tension and holding them taut across at least one dimension of backlight cavity 16 and/or of the viewable area of LCD panel 12, a sufficient stiffness or rigidity is achieved to enable them to prevent optical film stack 14 from sagging into backlight cavity 16, thus holding optical film stack 14 in a substantially flat condition. The contact between elongated support(s) 34 and optical film stack 14 maintains the flatness of optical film stack 14. Optical film stack 14 is thus supported by support posts 22 and elongated supports 34 such that optical film stack 14 remains in a substantially flat condition and is resistant to warping or sagging.

Filaments 34a-34c can be wires, ribbons, or similar thin, long structures, and can comprise organic or inorganic materials, such as carbon, nylon, plastic, metal, and the like. Although FIG. 2 depicts each elongated support 34 as having three filaments 34a, 34b, and 34c, the number of filaments in each support 34 can be chosen according to design constraints, and can, for example, be as small as one and as large as tens, hundreds, or one thousand or more. Filaments 34a-34c can have a thickness, i.e., a dimension along an axis perpendicular to backlight cavity 16 and to the front of LCD panel 12, suitable for the intended application, in some cases ranging from 0.01 millimeters (mm) to 10 mm depending on the material used to form filaments 34a-34c. The cross-sectional shape of thin filaments 34a-34c can be any suitable shape, including, but not limited to: circular, elliptical, rectangular, polygonal, etc. Additionally, although elongated supports 34 are shown in FIG. 2 as attaching at sides 26 and 30 to form a parallel array of supports, the arrangement of supports 34 can be changed as long as the resulting structure provides enough support to maintain optical film stack 14 in position relative to backlight cavity 16. For example, elongated supports 34 can form a crossed array, or a parallel and crossed mixed array. Elongated supports 34 can also have wide-angle variations with respect to each other or with surface 18. For example, if elongated supports 34 are a transparent material such as polymethyl methacrylate having a refractive index similar to the bottom substrate of optical film stack 14, elongated supports 34 can be relatively thick because the transparency and similar refractive index of elongated supports 34 do not produce a large change in the light path from contact with optical film stack 14. If, however, other materials such as inorganics or metals are used, elongated supports 34 should be relatively thin in order to prevent elongated supports 34 from being observed by the human eye when viewed from an observer in front of LCD system 10.

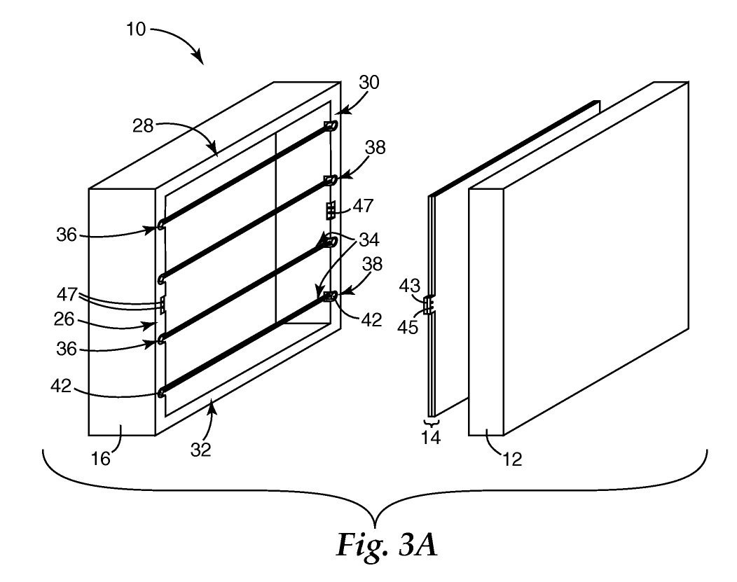

FIG. 3A shows an exploded perspective view of the LCD system 10 with light sources 20 and support posts 22 omitted for the sake of simplicity. FIG. 3B shows a blown-up view of LCD system 10 and will be discussed in conjunction with FIG. 3A. In addition to the use of support posts 22 and elongated supports 34 to contact a major surface of optical film stack 14 to keep optical film stack 14 flat, further mechanical stability can be obtained in a low profile design. A first end 36 of each of filaments 34a-34c is attached to posts 42 positioned along side 26 of surface 18, and a second end 38 of each of filaments 34a-34c is attached to posts 42 positioned along opposed side 30 of surface 18. Elongated supports 34 can be attached to LCD system 10 by: (a) threading first end 36 of filaments 34a-34c through posts 42 disposed on side 26 of surface 18; (b) pulling filaments 34a-34c taut across LCD system 10; and (c) threading second end 38 of filaments 34a-34c through posts 42 disposed on opposed side 30 of surface 18. Other attachment techniques known in the art can also be used, including, but not limited to: crimping, gluing, wrapping, or any combination thereof. As mentioned above, elongated supports 34 can be arranged to be parallel or non-parallel to each other.

To mount optical film stack 14 onto backlight cavity 18, optical film stack 14 preferably includes alignment tabs 43 located at one or more of its edges or boundaries. Perforations 45 extend through tabs 43 of optical film stack 14 and are sized and spaced to mate with corresponding protrusions 47 in an adjacent component such as surface 18 of backlight cavity 16. As shown in FIG. 3C, after filaments 34a-34c are attached to posts 42, optical film stack 14 can be mounted on backlight cavity 16 by inserting the exposed ends of protrusions 47 into corresponding perforations 45 of tabs 43 of optical film stack 14.

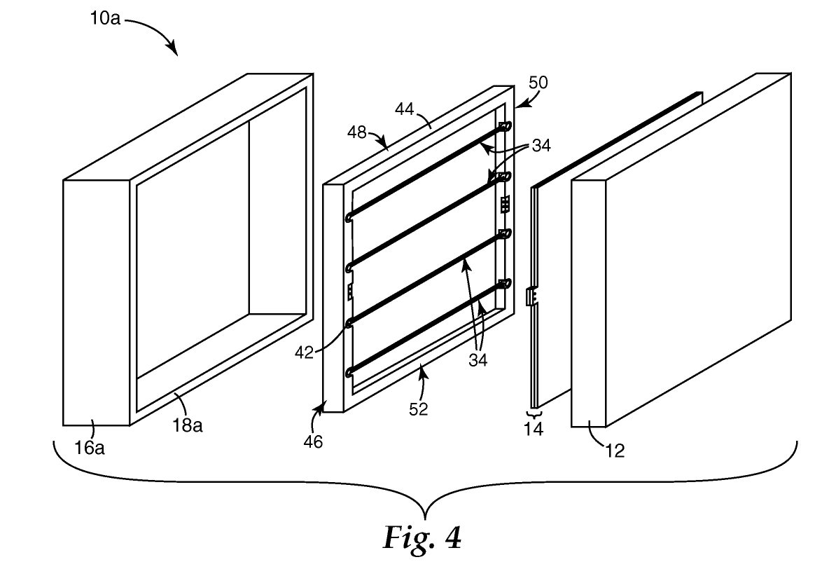

Rather than mounting elongated supports 34 directly to backlight cavity 16, elongated supports 34 can alternatively be mounted to a separate mounting frame or structure which is then attached or otherwise connected to backlight cavity 16. This is shown in the perspective view of FIG. 4, depicting an LCD system 10a that is similar to LCD system 10 but includes a mounting frame 44. LCD system 10a includes optical film stack 14 that attaches to mounting frame 44. LCD system 10a also includes backlight cavity 16a having surface 18a similar to backlight cavity 16 and surface 18, except that the former does not include posts 42 or protrusions 47. Mounting frame 44 can be sized to mate with backlight cavity 16a in any known manner. For example, mounting frame 44 can slidably engage the inside perimeter of backlight cavity 16a in a friction fit. Mounting frame 44 can also attach to backlight cavity 16a by an adhesive, mechanical means, or any combination thereof.

Mounting frame 44 has sides 46, 48, 50, and 52, which can be arranged to form a rectangle or other desired shape. As with backlight cavity 16, mounting frame 44 can utilize any known materials of construction and can utilize any design features that provide a low profile rigid body. The thickness of mounting frame 44 will depend on the size and thickness of LCD display 12 and the materials of construction. In some embodiments, mounting frame 44 has a thickness of 100 mm or less. Exemplary materials of construction include without limitation plastics, such as polypropylene, poly(ethylene terephthalate), polymethyl methacrylate, polycarbonate, and polyethylene, and metals, such as aluminum or stainless steel.

Mounting frame 44 can include posts 42 along some or all of its perimeter, as shown in FIG. 4. Such posts 42 can be used to attach elongated supports 34 to mounting frame 44 in the same manner as discussed in connection with FIG. 3. Elongated supports 34 can also be mounted to mounting frame 44 by an adhesive, mechanical means, or any combination thereof. By appropriate placement of mounting frame 44 within LCD system 10, at least filaments 34a are positioned such that they contact a major surface of optical film stack 14. Elongated supports 34 can, but need not be arranged parallel to each other, as discussed above in connection with FIG. 3.

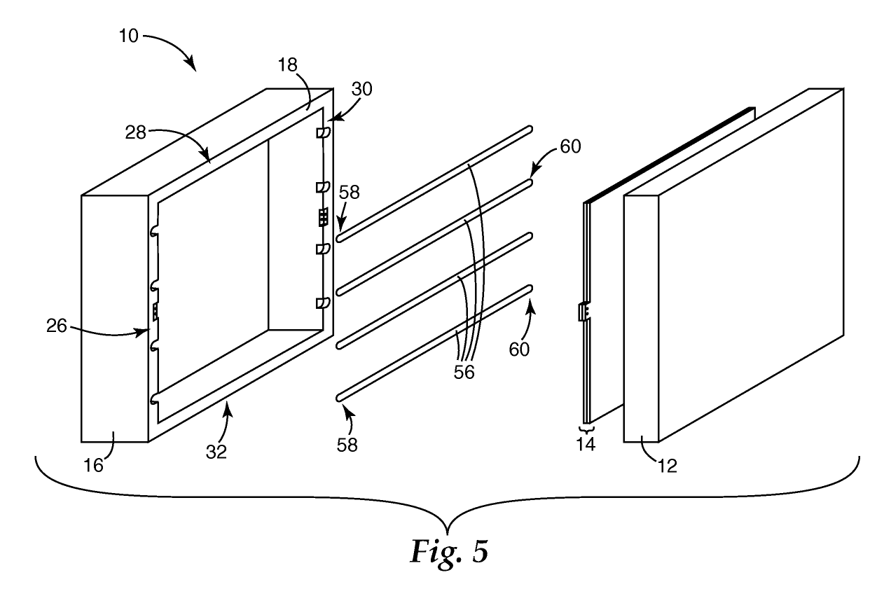

FIG. 5 is an exploded perspective view of another LCD system 100. Like the LCD systems of FIGS. 1-4, LCD system 100 utilizes elongated supports to contact optical film stack 14 and maintain it in a flat configuration. But unlike the previously described systems, LCD system 100 uses supports that are inherently rigid and stiff due to their composition and thickness, and do not need to be held taut or mounted in tension. Elongated supports 56 are positioned immediately adjacent optical film stack 14 and provide support to optical film stack 14 to prevent sagging away from LCD panel 12. Similar to elongated supports 34 shown in FIGS. 1-4, elongated supports 56 shown in FIG. 5 provide sufficient support to optical film stack 14 even though elongated supports 56 cover only select portions of optical film stack 14. Indeed, in exemplary embodiments the elongated supports both individually and collectively cover only a portion of the useful area of the optical film stack; preferably, the elongated supports collectively cover less than 50% of such useful area, and a given elongated support individually covers less than 25% of such useful area. “Useful area” in this regard refers of course to the (usually rectangular, with aspect ratio of e.g. 16:9 or 4:3) area of the film stack through with light passes on its way to the liquid crystal display, if present, and to the viewer. Elongated supports 56 prevent optical film stack 14 from sagging into backlight cavity 18. Elongated supports 56 thus help to maintain optical film stack 14 in a substantially flat condition without warping, sagging, curling, or the like.

Elongated supports 56 each have a first end 58 and a second end 60. As shown, first ends 58 attach to side 26 of surface 18, and second ends 60 attach to opposite side 30 of surface 18. As mentioned above, elongated supports 56 can, but need not be arranged in a parallel array. Skewed arrangements, intersecting arrangements, and other arrangements can also be used, but preferably the array of elongated supports 56 provides enough support to maintain optical film stack 14 in position relative to LCD panel 12.

The number of elongated supports 56 can range from one to tens, hundreds, or even one thousand or more. The thickness of each of elongated supports 56 will depend on the size and thickness of LCD display 12. The cross-sectional shape of the elongated supports 56 can be circular, elliptical, rectangular, polygonal, or any other desired shape.

Elongated supports 56 can be made of organic or inorganic materials, plastics, or metals. Exemplary supports 56 that are positioned within the display area are either transparent or sufficiently narrow (from the perspective of the observer in front of LCD system 100) as to not substantially interfere with the visual display as seen by the observer. Any elongated supports 56 not located within the display area need not be transparent, and can be formed of wider plastic or metal. Exemplary plastics include, but are not limited to: polypropylene, poly(ethylene terephthalate), polymethyl methacrylate, polycarbonate, and polyethylene. An exemplary metal includes, but is not limited to, aluminum.

Elongated supports 56 can be attached to backlight cavity 16 using any conventional techniques. For example, holes can be formed in the first and second ends 58, 60 of elongated supports 56 to engage corresponding posts in surface 18. Altematively, elongated supports 56 can be attached to surface 18 or to a separate mounting frame by an adhesive or mechanical means.

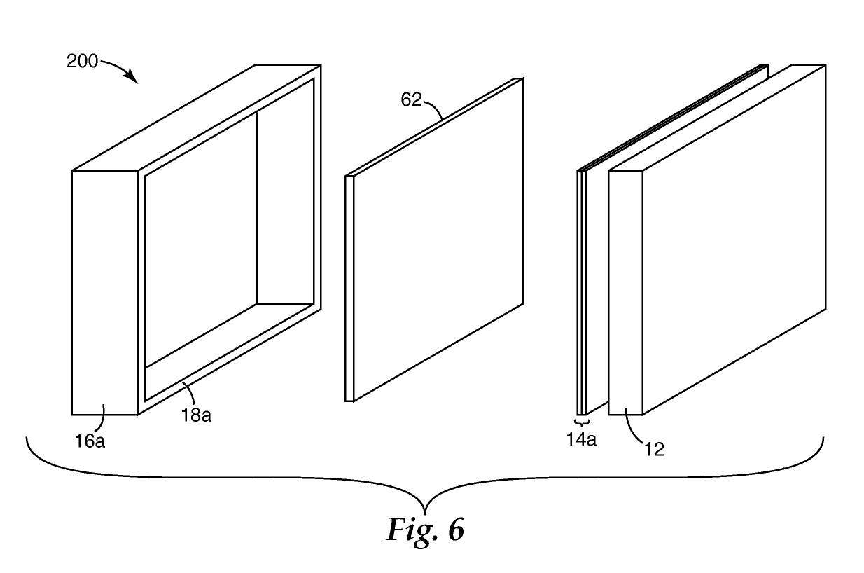

FIG. 6 shows an exploded perspective view of another LCD system 200. LCD system 200 includes optical film stack 14a similar to optical film stack 14, except that the former does not include any alignment tabs 43. Of course, film stack 14a can be readily modified if desired to include perforated alignment tables that engage corresponding protrusions as discussed in the embodiments above. LCD system 200 uses a stretched film 62 as a support. Stretched film 62 is mounted to contact optical film stack 14a and to maintain optical film stack 14a in a substantially flat condition. Like elongated supports 34 discussed in connection with FIGS. 1-4, stretched film 62 is a flexible support, made using a component (in this case, a light-transmissive film) that is inherently flexible, and thus susceptible to warping, curling, sagging, and so on, but that is held taut to provide enough rigidity so that it can exert pressure against optical film stack 14a. In contrast to elongated supports 34 of FIGS. 1-4 and elongated supports 56 of FIG. 5, stretched film 62 contacts substantially an entire major surface of optical film stack 14a in order to prevent optical film stack 14a from sagging into backlight cavity 16a.

Stretched film 62 is or comprises a flexible sheet of light-transmissive material that is stretched across surface 18a or across some other frame or structure within LCD system 200. Stretched film 62 may be made of any material that is substantially transparent to visible light, including without limitation plastic materials such as polypropylene, poly(ethylene terephthalate), and polyethylene. In exemplary embodiments, stretched film 62 is or comprises a thermal shrinkage film. Such a film can be readily incorporated into LCD system 200 by: (1) bonding stretched film 62 (in an unstretched condition) to surface 18a, or to a separate mounting frame or similar structure, with an adhesive or other conventional bonding mechanism; and (2) applying heat to stretched film 62 such that it permanently contacts enough to become uniformly taut within surface 18a. Such a shrinkage film is considered to be a “stretched film” for purposes of this application because the film is held in tension, even though such tension results from shrinkage instead of an expansion of the film. Of course, stretched film 62 can also be made by mechanically stretching a film (e.g., by holding the film in a gripping mechanism and pulling apart the jaws that hold opposing edges of the film) and then mounting the stretched film on a frame to maintain the tension in the film. If desired, stretched film 62 can be laminated to one or more films of optical film stack 14a, including in some cases to a diffuser film in optical film stack 14a. Stretched film 62 can also provide optical functionality. For example, stretched film 62 can be or comprise a diffuser film or other optical film suitable for use in optical film stack 14a.

The present application contemplates LCD systems that incorporate any combination of features disclosed in the various LCD systems discussed above. For example, an LCD system can include one or more elongated supports 56 extending across the width of the backlight cavity as well as one or more elongated supports 34 extending across the length of surface 18, the latter elongated supports 34 intersecting and optionally perpendicular to elongated supports 56.

The disclosed LCD systems preferably comprise an LCD panel, an optical film stack, and a backlight cavity. The systems also include a supporting structure that supports the optical film stack with respect to the LCD panel of the LCD unit. The supporting structure applies pressure to the optical film stack to prevent the optical film stack from sagging into the backlight cavity and to maintain the optical film stack in a substantially flat condition.

Although the present invention has been described with reference to preferred embodiments, workers skilled in the art will recognize that changes may be made in form and detail without departing from the spirit and scope of the invention.

1. A liquid crystal display (LCD) unit, comprising:
an LCD panel;
a backlight cavity;
a film stack comprising at least one flexible optical film disposed between the LCD panel and the backlight cavity; and
a supporting structure disposed to maintain the film stack in a substantially flat condition, the supporting structure comprising at least one of (A) a flexible support held taut in at least one dimension, and (B) a rigid elongated support covering only a portion of a useful area of the film stack.

2. The LCD unit of claim 1, wherein the supporting structure comprises a flexible support held taut in at least one dimension.

3. The LCD unit of claim 2, wherein the flexible support comprises a filament.

4. The LCD unit of claim 2, wherein the flexible support comprises a plurality of filaments.

5. The LCD unit of claim 2, wherein the flexible support comprises a stretched film.

6. The LCD unit of claim 5, wherein the stretched film is a thermal shrinkage film.

7. The LCD unit of claim 1, wherein the supporting structure comprises a plurality of rigid elongated supports that collectively cover only a portion of the useable area of the film stack.

8. The LCD unit of claim 1, wherein the backlight cavity includes a surface, and the supporting structure is mounted to the surface.

9. The LCD unit of claim 8, further comprising:
means for attaching the supporting structure to the surface.

10. The LCD unit of claim 9, wherein the means comprises a protrusion, an adhesive, a mechanical fastener, or combinations thereof.

11. The LCD unit of claim 1, wherein the backlight cavity includes a surface, wherein the LCD unit further comprises a mounting frame, and wherein the supporting structure is mounted to the mounting frame.

12. The LCD unit of claim 11, further comprising:
means for attaching the supporting structure to the mounting frame.

13. The LCD unit of claim 12, wherein the means comprises a protrusion, an adhesive, a mechanical fastener, or combinations thereof.

14. The LCD unit of claim 1, wherein the supporting structure contacts at least a portion of a major surface of the film stack.

15. The LCD unit of claim 14, wherein the supporting structure contacts selected portions of the major surface of the film stack.

16. The LCD unit of claim 14, wherein the supporting structure contacts substantially all of the major surface of the film stack.

17. The LCD unit of claim 1, wherein the supporting structure causes the film stack to contact the LCD panel.

18. The LCD unit of claim 1, further comprising:
a support post attached to the backlight cavity.
